(19) United States
(12) Patent Application Publication
(10) Pub. No.: US 2006/0180403 A1
(43) Pub. Date: Aug. 17, 2006

(54) Screw scissor lift

(76) Inventor: Mark T. Hanlon, Costa Mesa, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/320,213

(22) Filed: Dec. 27, 2005

Related U.S. Application Data
(60) Provisional application No. 60/642,267, filed on Jan. 7, 2005.

(51) Int. Cl. B66B 9/02

(52) U.S. Cl. 187/269

(57) ABSTRACT

A scissor lift includes an energy storage device that stores energy as the payload is lowered, and provides further lift to the payload as the payload is raised. This allows the scissors to achieve a support angle of up to 180° between the two arms (down to 0° between the screw drive and the lowest arm of the scissors), making the inventive scissor lifts considerably more compact than prior art lifts. The energy storage device is preferably a helical wire spring, but can alternatively be any suitable spring, piston, or even an elastomeric mass. Side to side movement of the scissors arms can be restricted using a thrust bearing with hardened washers at the inter-arm pivot, and/or a guided connector that transmits motive force to the scissors.

This application claims priority to U.S. provisional application Ser. No. 60/642,267 filed Jan. 7, 2005.

### FIELD OF THE INVENTION

The field of the invention is scissor lifts.

### BACKGROUND OF THE INVENTION

Scissor lifts have been widely used across many applications for many years. Among other things, such lifts have been used to raise automobiles and other heavy equipment, people, building components, supplies, structural components, and to provide scaffolding, work stands, patient beds and so forth. Operation of the scissor must be operated in some manner, and in some instances the scissor is operated using a screw drive. Examples in the patent literature include U.S. Pat. No. 6,719,282 to Frank (April 2004); U.S. Pat. No. 6,684,443 to Thomas et al. (February 2004); US20040005961 to lund et al. (January 2004); U.S. Pat. No. 6,655,875 to Pignato (December 2003); U.S. Pat. No. 5,996,961 to Johnson (December 1999); and U.S. Pat. No. 5,593,137 to Johnson (January 1997); U.S. Pat. No. 5,105,915 to Gary (April 1992); and U.S. Pat. No. 3,817,346 to Wehmeyer (June 1974). This and all other referenced patents and applications are incorporated herein by reference in their entirety. Where a definition, or use of a term in a reference incorporated by reference, is inconsistent or contrary to the definition of that term provided herein, the definition of that term provided herein applies and the definition of that term in the reference does not apply.

Despite these varied uses, and the considerable experience of decades of use, there are still problems associated with screw-type scissor lifts. One problem is that the screw mechanism tends to bind. Another problem is that there is a very significant mechanical disadvantage-working against extension of the scissor mechanism in a compressed position. In prior art scissors, the retraction must usually provide at least a 10° angle between the screw drive and the lowest arm of the scissors. That problem can be resolved by limiting the extent to which the scissor mechanism can retract, but then the mechanism is not so compact as one might prefer.

Thus, there still remains a need for improvements in screw-type scissor lifts.

### SUMMARY OF THE INVENTION

The present invention provides apparatus, systems and methods in which a scissor lift for lifting a payload, comprises a first pair of scissored arms disposed to lift the payload and an energy storage device disposed to store energy as the payload is lowered, and provide further lift to the payload as the payload is raised.

At a fully retracted position, the scissored arms define a support angle of at least 150°, more preferably at least 165°, still more preferably at least 175°, and most preferably 180°. At the extreme of 180°, this corresponds to an angle of 0° between the screw drive and the lowest arm of the scissors, which means that such scissor lifts can be considerably more compact than prior art lifts.

In another aspect of preferred embodiments, a bearing is used at a pivot joining the first and second arms, with hardened washers on either sides of the bearing. These features help reduce side to side sway of the scissor mechanism, and therefore of the payload. In especially preferred embodiments the bearing is sufficiently stiff to restrict side to side movement of the payload such that movement of the payload under operation of the lift is substantially planar.

In still another aspect of preferred embodiments, a screw, piston, cable, chain, rack and pinion or other actuator is mechanically coupled to one of the scissor arms to provide motive force to the lift. In especially preferred embodiments the actuator drives both arms of the lowest (or only) pair of scissor arms.

There must be some source of motive force that drives the actuator, and in preferred embodiments that source comprises an electric motor.

The energy storage device is preferably a helical wire spring, but can alternatively be any suitable spring, whether helical or non-helical, having thin or thick wires, and whether constructed of metals, non-metals, or a combination. In still other embodiments the energy storage device could be a flat spring, a gas piston, or even a piece of rubber or other elastomeric mass.

Contemplated lifts can comprise more than one pair of scissored arms, either laterally adjacent to one another, or more likely stacked on top of one another. At the lower end of the lift, the bottom (or only) pair of scissors is preferably coupled to a substantially immovable base at spaced apart first and second pivots, and a connector that transmits motive force to the scissors is restricted by a guide to movement substantially within a single plane. At the upper end of the lift, the top (or only) pair of scissors is preferably coupled to a movable platform at spaced apart third and fourth pivots. The moveable platform directly or indirectly supports the payload.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIGS. 1A, 1B are partial cutaway perspective views of a cabinet containing a scissor lift that can be used in conjunction with a plasma television or other screen.

FIG. 2 is a perspective view of the lift of FIGS. 1A, 1B, in an extended configuration.

FIG. 3 is a perspective view of the base assembly of the lift of FIGS. 1A, 1B.

FIG. 4 is a perspective view of the bogie of the lift of FIGS. 1A, 1B.

FIG. 5 is a perspective view of the scissor arm bearings of the lift of FIGS. 1A, 1B.

FIG. 6 is a perspective view of the upper platform assembly of the lift of FIGS. 1A, 1B.

FIG. 7 is a perspective view of the safety cap assembly of the lift of FIGS. 1A, 1B.

FIG. 8 is a perspective view of the lift of FIGS. 1A, 1B, with a controller assembly.

FIG. 9 is a perspective side view of the lift of FIGS. 1A, 1B, to clearly depict the support angle.

### DETAILED DESCRIPTION

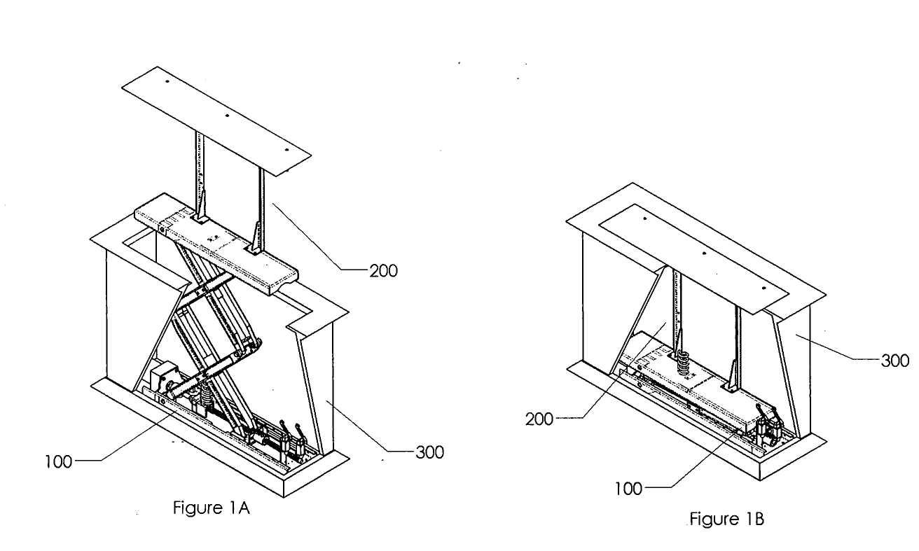

FIGS. 1A and 1B generally depict a lift 100 supporting a plasma screen 200 and a cabinet 300. In FIG. 1A the screen is fully extended to a viewing position outside the cabinet 300, and in FIG. 1B the fully retracted screen is descended into the main cavity of cabinet 300. The lift 100 generally includes a base assembly 110, counter balance spring 111, a thrust bearing frame 112, a thrust bearing 113, a thrust bearing race 114, a shaft bearing 115, a drive screw 116, a drive nut assembly 117, and a base frame 118.

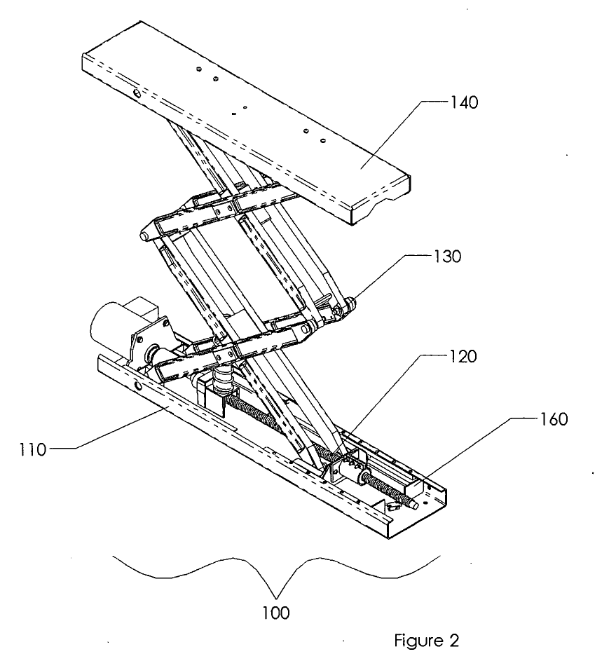

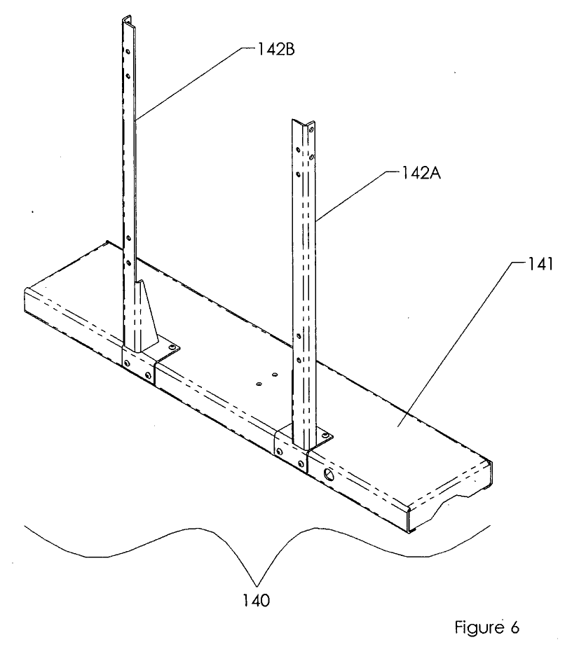

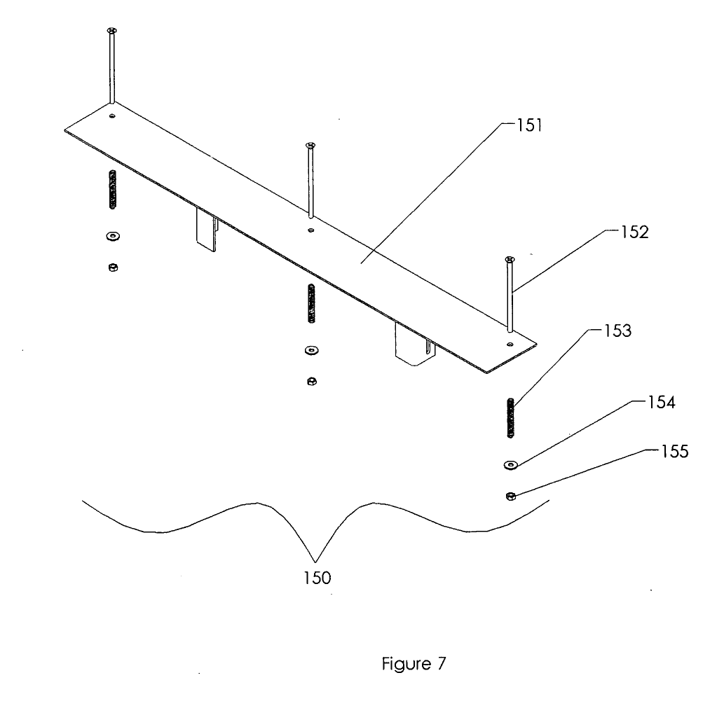

In FIG. 2 the lift 100 is shown supporting a superstructure comprising a platform assembly 140, which is coupled to a cap frame 150. Details of the superstructure are better visualized in FIGS. 6 and 7, which show the upper platform assembly 140 as including a upper platform frame 141 and screen brackets 142A, 142B. The cap frame 150 generally includes a cap 151, a machine screw 152, springs 153, washers 154, and nuts 155. The springs 153 permit self-leveling or other accommodation of the cap along the horizontal surface of a table or other structure in which the cabinet 300 is mounted. The cap 151 can advantageously fit into the top of a table or other structure using a beveled groove and key arrangement.

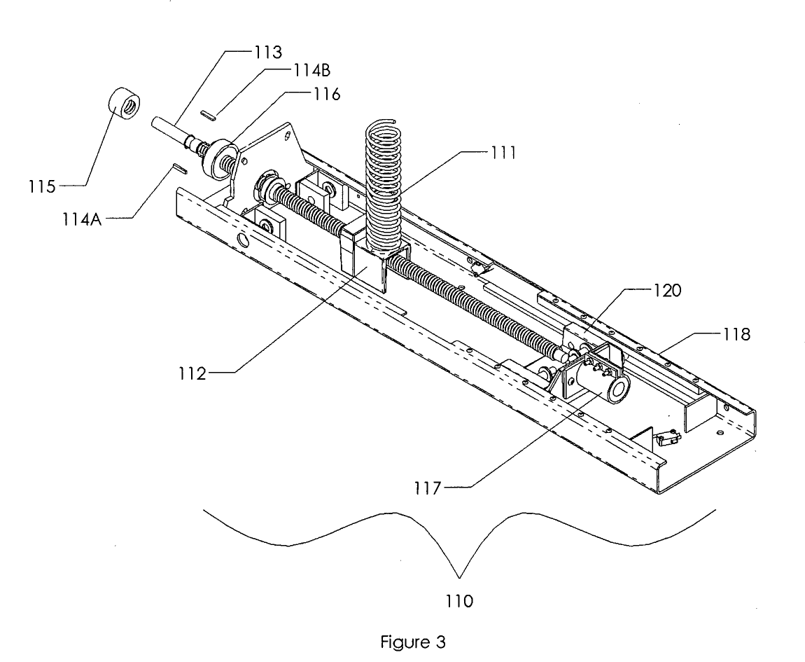

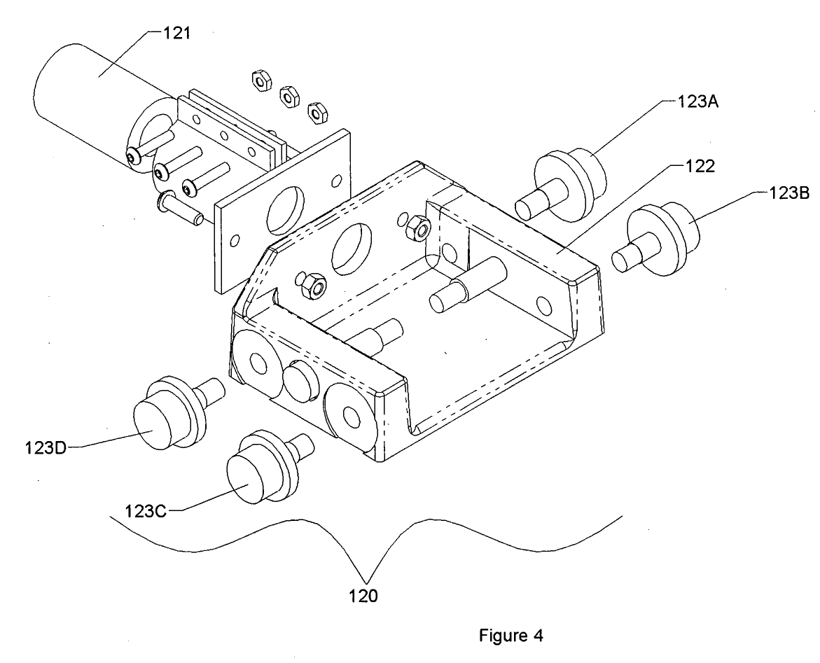

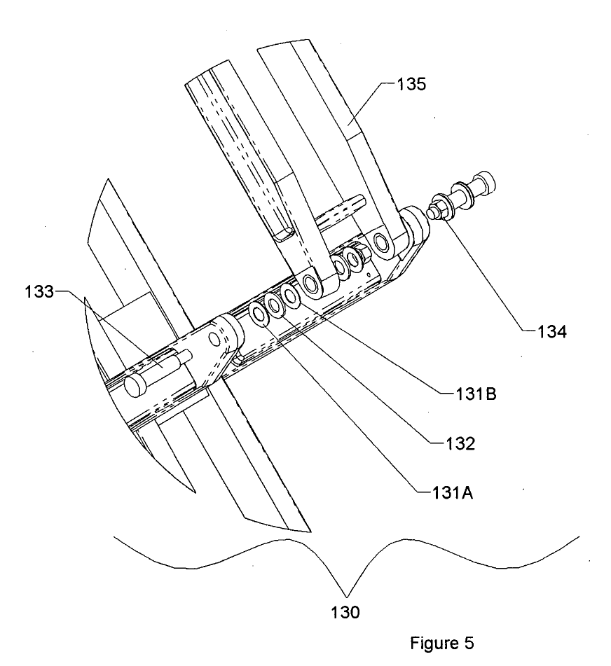

In FIGS. 3-5 the base assembly 110 supports a bogie 120, which generally includes a drive nut 121, a bogie frame 122, and a wheel 123 (cam follower). The bearing joint 130 generally includes a thrust bearing race 131, a thrust bearing 132, a shoulder bolt 133, a shoulder bolt nut 134, and a scissor frame 135.

The binding problem alluded to above is resolved by using a thrust bearing on one end, but not on the other. The mechanical disadvantage problem is resolved by using a spring, gas cylinder, fluid spring, or other biasing element that adds additional force when the scissors is in a highly retracted configuration. The biasing element can be positioned as shown in the figures, or in many other configurations that provide a similar function. The spring can even, for example, be disposed about the screw. In preferred embodiments the biasing element provides and additional force up to 10 times that provided by the screw, and allows screw drive/scissors angles of 5° or even less. Currently preferred springs provide force of 50 pounds per inch, and are between 3″ and 12″ long. In some embodiments springs or different force profiles can be interchanged, and can be color coded or marked in some other manner to accommodate different desired lift characteristics.

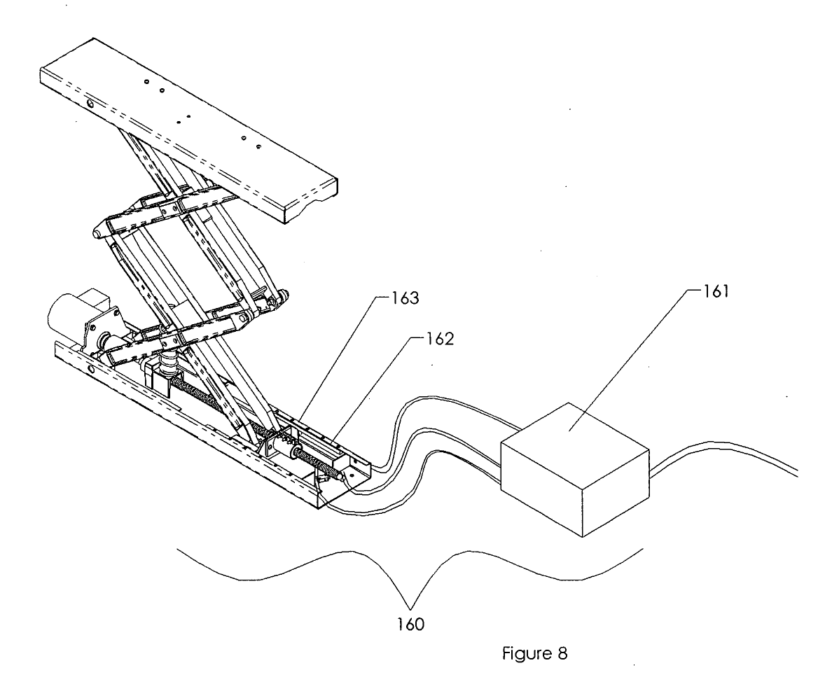

FIG. 8 additionally depicts a control assembly 160, which generally includes a digital controller 161, a stop limit switch 162, and a slow limit switch 163. Reducing the speed as the lift retracts at low angles (creep mode) allows much greater accuracy in positioning, and greatly improves the safety profile. It also helps prevent overload on the screw/motor. The controller preferably controls a high torque electric motor. Capacity of contemplated embodiments is 200 # or more of load.

The lift is in communication with a drive controller 161. The drive controller 161 can be used to control and/or provide power to the drive mechanism (not shown) of the lift 410. A preferred drive controller has a transceiver or receiver in order to receive signals from a remote control device. It is further contemplated that a lift can be incorporated into a home appliance center and control of the lift can therefore be accomplished using a computer or other device programmed to control home appliances. Such control can also be accomplished remotely from a distal location, if necessary. It may be desirable for a parent to monitor a child's “T.V. time”, and as such, enhancements can be built into the controller that can prevent the lift and or the projector from operation without authority.

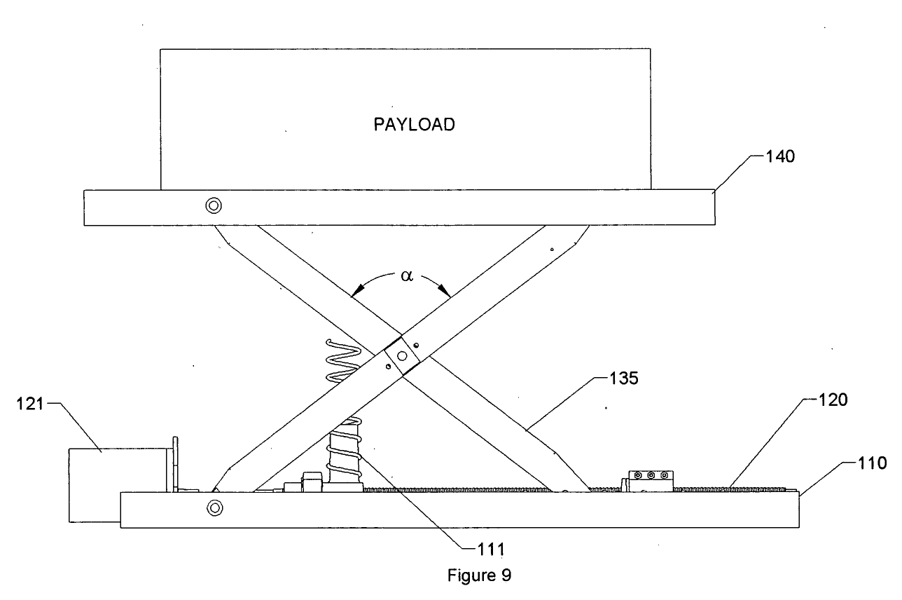

FIG. 9 generally depicts a lift supporting a payload which special emphasis on the support angle α. The lift base frame 110 supports the scissors arms 135, the helical wire spring 111, the electric motor 121, and the actuator screw. The scissor arms 135, are driven by the actuator screw 120. The scissor arms 135, supports the upper platform assembly 140, which supports the payload.

Thus, specific embodiments and applications of a screw scissor lift have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A scissor lift for lifting a payload, comprising:
a first pair of scissored arms disposed to lift the payload, and that travel between an extended position and a retracted position; and
an energy storage device disposed to store energy as the payload is lowered, and provide further lift to the payload as the payload is raised.

2. The scissor lift of claim 1, wherein the scissored arms define a support angle of at least 150° at the retracted position.

3. The scissor lift of claim 2, wherein the support angle is at least 165° at the retracted position.

4. The scissor lift of claim 2, wherein the support angle is at least 175° at the retracted position.

5. The scissor lift of claim 2, wherein the support angle is 180° at the retracted position.

6. The scissor lift of claim 1, further comprising a bearing at a pivot joining the first and second arms.

7. The scissor lift of claim 6, further comprising a first hardened washer on a side of the bearing and a second hardened washer on an opposing side of the bearing.

8. The scissor lift of claim 6, wherein the bearing is sufficiently stiff to restrict side to side movement of the payload such that movement of the payload under operation of the lift is substantially planar.

9. The scissor lift of claim 1, further comprising an actuator mechanically coupled to at least one of the scissor arms that provides motive force to the lift.

10. The scissor lift of claim 9, wherein the actuator comprises a screw.

11. The scissor lift of claim 9, wherein the actuator is selected from the group consisting of piston, a cable, a chain, and a rack and pinion.

12. The scissor lift of claim 9, wherein the actuator is mechanically coupled to both of the scissor arms.

13. The scissor lift of claim 9, further comprising a source of motive force that drives the actuator.

14. The scissor lift of claim 13, the source comprises a motor.

15. The scissor lift of claim 13, the source comprises an electric motor.

16. The scissor lift of claim 1, wherein the energy storage device comprises a wire spring.

17. The scissor lift of claim 1, wherein the energy storage device is selected from the group consisting of a flat spring, a gas piston, and an elastomeric mass.

18. The scissor lift of claim 1, wherein the energy storage device extends between a base and a moveable platform that supports the payload.

19. The scissor lift of claim 18, further comprising a first pivot coupling the base to one of the scissored arms.

20. The scissor lift of claim 1, further comprising a second pair of scissored arms operationally coupled to the first pair of scissored arms.

21. The scissor lift of claim 1, further comprising a connector that transmits motive force to at least one of the scissor arms, and a guide that restricts movement of the connector to a single plane.
